(19) United States
(12) Patent Application Publication
(10) Pub. No.: US 2009/0055203 A1
(43) Pub. Date: Feb. 26, 2009

(54) METHOD, PROGRAM CODE, AND SYSTEM FOR BUSINESS PROCESS ANALYSIS

(75) Inventors: Christine E. Dicken, Laveen, AZ (US); Gregory L. Yung, Tempe, AZ (US)

Correspondence Address: MESCHKOW & GRESHAM, P.L.C., 5727 NORTH SEVENTH STREET, SUITE 409, PHOENIX, AZ, 85014, US

(73) Assignee: ARIZONA PUBLIC SERVICE COMPANY, Phoenix, AZ (US)

(21) Appl. No.: 11/843,488

(22) Filed: Aug. 22, 2007

(51) Int. Cl. G06Q 10/00

(52) U.S. Cl. 705/1

(57) ABSTRACT

Program code (36) executed on a system (20) entails a method (98) for analysis of a business process (16). The method (98) obtains a model (42) of the business process (16) identifying actions (106) that are part of the business process (16). Each action (106) is categorized into an action category (53) according to an action verb (84) that describes the action (106), and a quantity (146) of actions (106) for each action category (53) is computed. Actions (106) are also identified as being either a primary action (90) or a support action (92). A report (22) is assembled and provided so that a user can visualize the efficacy of the business process (16). The report (22) includes visual representations of quantities (146) of actions (106) in each action category (53) and amounts of actions (106) that are primary actions (90) relative to support actions (92).

### TECHNICAL FIELD OF THE INVENTION

The present invention relates to the field of business process management. More specifically, the present invention relates to computer-assisted business process analysis for quantifying and visualizing the efficacy of a business process.

### BACKGROUND OF THE INVENTION

Business Process Management (BPM) is a field of knowledge generally encompassing methods, techniques and tools to design, perform, control, and analyze business processes involving humans, equipment, organizations, applications, documents and other sources of information. One goal of BPM is to provide a systematic approach to improving those business processes.

A business process can be defined broadly as a collection of interrelated tasks that achieve a particular objective or solve a particular issue. A business process may be decomposed into several sub-processes, which have their own attributes, but also contribute to achieving the objectives of the business process. Analysis of business processes typically includes the mapping or modeling of processes and sub-processes down to activity level, i.e., those actions that need to be carried out within the business process.

Optimization of a business process can lead to cost savings, greater stakeholder satisfaction, and better retention of a valuable customer base. However, before organizations can optimize operational efficiency there is a need to ensure that existing business processes are fully understood, and that all key activities, or actions, are taken into consideration when changes to improve business processes are made. Business process modeling tools have been developed and are evolving to assist organizations to work with, better understand, and re-align an organization's business processes and systems.

These business process modeling tools can be utilized to document and review an organization's business processes. Unfortunately, these modeling tools are typically used without objective analysis criteria. In some circumstances, best practice experts have been consulted about the business processes. Usually, however, business process analysis is left to the subjective analysis of individuals working in an “as is” or current state of the business process. This subjective analysis is often performed manually, which is time consuming, costly, and inefficient. As a result, execution of business processes cannot be standardized, organizations cannot clearly determine when changes are required and where those changes should be implemented within a business process, and modification to a business process, i.e. to a “to be” state, cannot be objectively compared with a current business process, i.e., in an “as is” state. Accordingly, what is needed is a technique for objective, automated analysis of a business process.

### SUMMARY OF THE INVENTION

Accordingly, it is an advantage of the present invention that a method, executable code, and a system are provided for analysis of a business process within an organization.

It is another advantage of the present invention that a method, executable code, and system are provided that yield objective analysis criteria for determining the efficacy of a business process.

Another advantage of the present invention is that the method, executable code, and system produce objective analysis criteria that are readily visualized by a user.

Yet another advantage of the present invention is that the method, executable code, and system provide automated analysis of a business process.

The above and other advantages of the present invention are carried out in one form by a method for computer-assisted analysis of a business process within an organization. The method calls for obtaining a model of the business process, the model identifying actions that are part of the business process. Each of the actions is categorized into an action category selected from a set of action categories and a quantity of the actions for each action category from the set is computed. A report is assembled that includes a visual representation of the quantity of the actions for each action category and the report is provided to a user so that the user can visualize an efficacy of the business process.

The above and other advantages of the present invention are carried out in another form by a computer-readable storage medium containing executable code for instructing a processor to analyze a business process within an organization. The executable code instructs the processor to perform operations that include obtaining a model of the business process, the model identifying actions that are part of the business process, identifying those actions that are primary actions, the primary actions describing value adding activities of the business process, and identifying other actions that are support actions, the support actions describing non-value adding activities within the business process. The executable code instructs the processor to perform further operations that include computing a first amount of the primary actions and a second amount of the support actions and providing a report to a user that distinguishes the first amount of the primary actions from the second amount of the support actions within the business process so as to enable a user to visualize an efficacy of the business process.

The above and other advantages of the present invention are carried out in yet another form by a system for modeling and analyzing a business process within an organization. The system includes a processor, a computer-readable storage medium, executable code recorded on the computer-readable storage medium, and an output element in communication with the processor. The executable code includes a business process modeler segment for instructing the processor to create a model of the business process, the model identifying actions that are part of the business process. The executable code further includes a business process analysis segment for instructing the processor to categorize each of the actions into an action category selected from a set of action categories, compute a quantity of the actions for each action category from the set, and assemble a report that includes a visual representation of the quantity of the actions for each action category. The report is provided to a user via the output element so that the user can visualize an efficacy of the business process.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a diagram of a business process decomposed into a number of sub-processes;

FIG. 2 shows a block diagram of a computing system in which analysis of a business process and provision of an analysis report can take place in accordance with the present invention;

FIG. 3 shows a table of phases of a business process lifecycle;

FIG. 4 shows a table of action categories and their definitions utilized in an embodiment of the present invention;

FIG. 5 shows a table of an action verb database that includes action verbs and their corresponding action types and action categories utilized in conjunction with the present invention;

FIG. 6 shows a flowchart of a modeling and analysis process in accordance with the present invention;

FIG. 7 shows a table of a number of actions that are part of a business process;

FIG. 8 shows a table of an assessment of the actions of the business process in accordance with the present invention;

FIG. 9 shows a diagram of a first portion of a report generated in response to the execution of modeling and analysis process of FIG. 6 and provided to a user;

FIG. 10 shows a diagram of a second portion of a report generated in response to the execution of the modeling and analysis process of FIG. 6 and provided to a user; and

FIG. 11 shows a diagram of a report provided in response to a subsequent execution of the modeling and analysis process.

### DETAILED DESCRIPTION OF THE PREFERRED EMBODIMENTS

The present invention entails a computer-assisted method, computer-readable medium containing executable code, and a system for analyzing a business process within an organization. The present invention yields automated analysis of a business process and enables an analyst to obtain and assess objective analysis criteria that may be utilized to ascertain the efficacy of a current, or “as is” business process and to objectively compare its performance to a modified, or “to be” business process. In particular, the present invention enables an analyst or organization to determine whether the objectives being met by a business process are in alignment with the desired objectives of that business process.

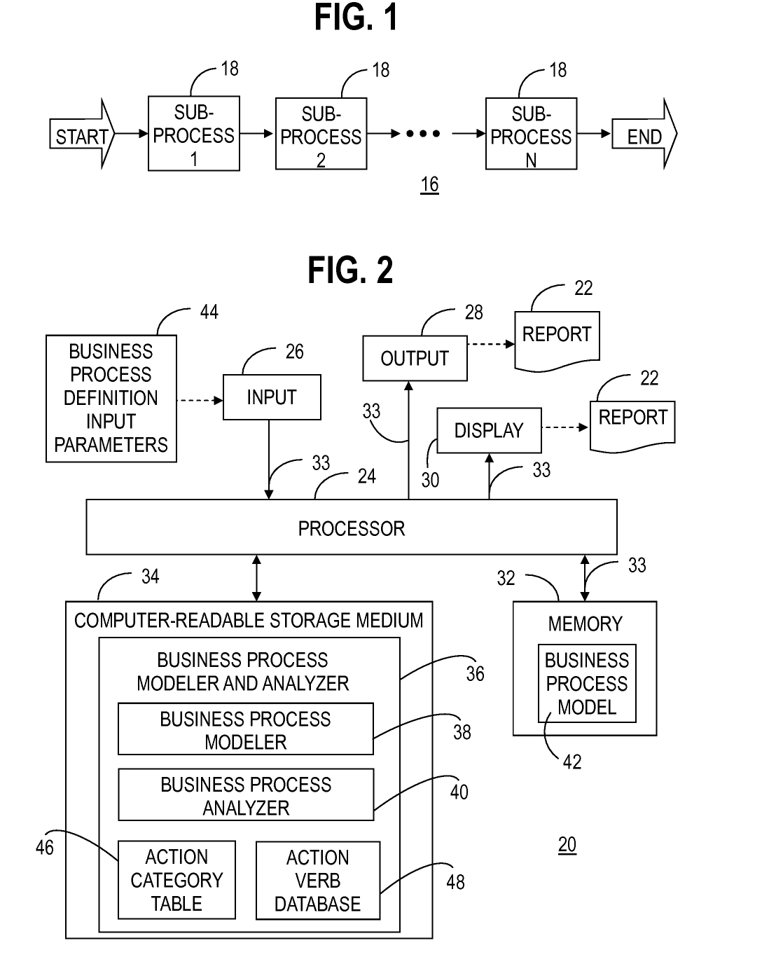

FIG. 1 shows a diagram of a business process 16 decomposed into a number of sub-processes 18. Business process 16 is a set of coordinated tasks and activities, conducted by both people and equipment, that leads to accomplishing a specific organizational objective. Sub-processes 18 have their own attributes, but also contribute to achieving the objectives of business process 16. The coordinated tasks and activities within business process 16 and sub-processes 18 of process 16 are referred to herein as actions.

Business process 16 can support a physical process. A physical process may entail the conversion of raw materials to a finished product or may entail the provision of an intangible service, such as medical, legal, or financial service. The objective of business process 16 is to not only support the physical process but to additionally meet the requirements of running a business, such as paying employees, reporting to a board of directors, and so forth. A well designed and implemented business process 16 ensures the effective and efficient use of an organization's resources.

FIG. 2 shows a block diagram of a computing system 20 in which analysis of business process 16 (FIG. 1) and provision of an analysis report 22 can take place in accordance with the present invention. Computing system 20 includes a processor 24 in communication with an input element 26, an output element 28, a display 30, and a memory system 32. These elements are interconnected by a bus structure 33.

Input element 26 can encompass a keyboard, mouse, pointing device, audio device (e.g., a microphone), and/or any other device providing input to processor 24. Output element 28 can encompass a printer, an audio device (e.g., a speaker), and/or other devices providing output from processor 24. Input and output elements 26 and 28 can also include network connections, modems, or other devices used for communications with other computer systems or devices via a communication network (not shown) such as an organization specific intranet or the ubiquitous Internet.

Computing system 20 also includes a computer-readable storage medium 34. Computer-readable storage medium 34 may be a magnetic disk, compact disk, or any other volatile or non-volatile mass storage system readable by processor 24. Computer-readable storage medium 34 may also include cooperating or interconnected computer readable media, which exist exclusively on computing system 20 or are distributed among multiple interconnected computer systems (not shown) that may be local or remote.

Business process modeler and analyzer program code 36, in accordance with one embodiment of the present invention, is contained on computer-readable storage medium 34. Code 36 includes a business process modeler segment 38 and a business process analyzer segment 40 that instructs processor 24 to perform modeling and analysis functions, as discussed below. In general, business process modeler segment 38 diagrams actions (discussed below) within business process 16 (FIG. 1) to form a business process model 42 that can be stored in memory system 32. Business process definition input parameters 44 of business process 16 may be entered into computing system 20 by a user via input element 26 for use by business process modeler segment 38.

In accordance with the present invention, business processor analyzer segment 40 assesses the diagramed actions that are part of business process model 42 to produce a quantified, objective report 22 of the efficacy of business process 16. Report 22 may be provided on display 30 and/or may be provided via output element 28. In one embodiment, business process modeler segment 38 and business process analyzer segment 40 are realized as a single, integrated process, i.e., code 36. However, it should be understood that business process modeler segment 38 and business process analyzer segment 40 may be distinct physical units, and need not be executed on the same computing system.

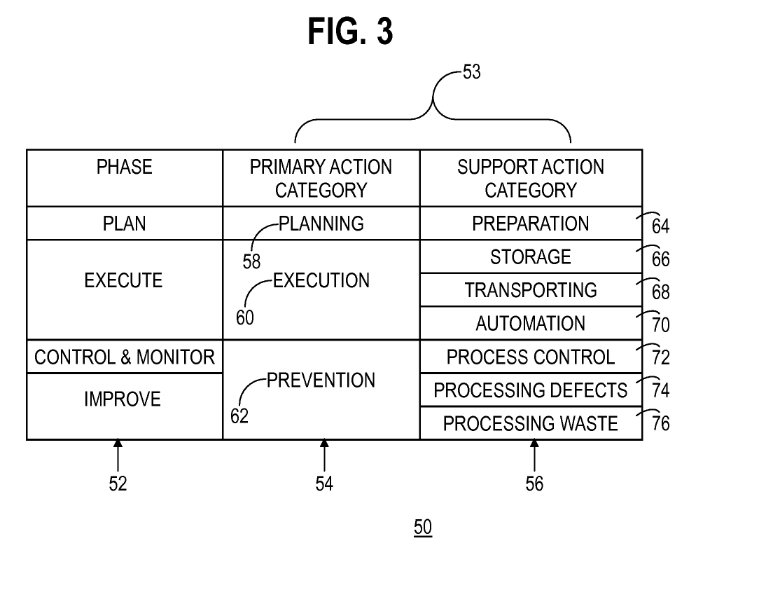

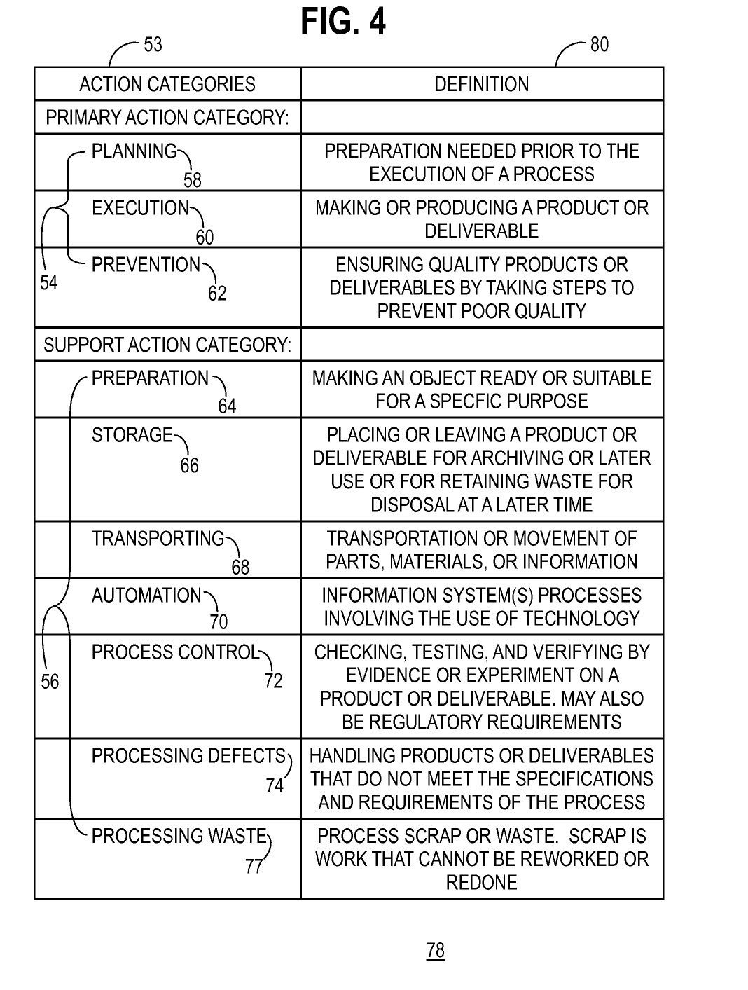

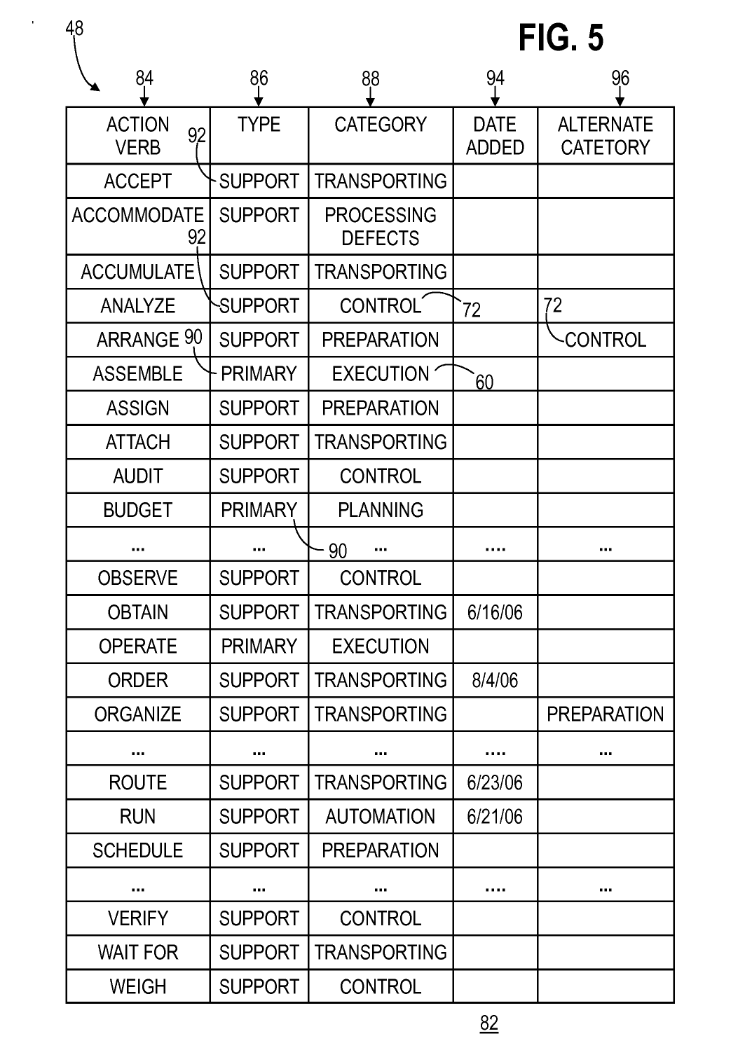

Business process modeler and analyzer program code 36 further includes an action category table 46 and an action verb database 48. Action category table 46 provides a framework for analysis of business process 16 (FIG. 1), and will be discussed in connection with FIGS. 3-4. Action verb database 48 includes a comprehensive listing of action verbs that are commonly utilized to describe actions or activities occurring within business process 16. Action verb database 48 is utilized in connection with the analysis of business process 16 and will be discussed in connection with FIG. 5.

FIG. 3 shows a table 50 of phases 52 of a business process life cycle. In this exemplary scenario, four phases 52 of a typical business process life cycle include plan, execute, control and monitor, and improve. As mentioned briefly above, business processor analyzer segment 40 (FIG. 2) assesses the diagramed actions that are part of business process model 42 (FIG. 2) to produce a quantified, objective report 22 of the efficacy of business process 16 (FIG. 1). Table 50 provides a framework for associating the various actions of business process 16 with phases 52 of the business process life cycle in order to produce report 22.

Table 50 includes a set of action categories 53 subdivided into a number of primary action categories 54 and a number of support action categories 56. Table 50 associates primary action categories 54 and support action categories 56 with phases 52 of a business process life cycle. In accordance with the present invention, primary action categories 54 classify or categorize those actions within business process 16 (FIG. 1) that produce a valued physical product, information, report, or service to a customer. These “primary” actions are sometimes referred to as a value chain of value adding actions since they produce a valued product or service to a customer. Primary action categories 54 utilized herein include a planning action category 58 associated with plan phase 52, an execution action category 60 associated with execute phase 52, and a prevention action category 62 associated with control and monitor and improve phases 52.

Support action categories 56 classify or categorize those activities within business process 16 that are support actions that support the business, but do not produce a valued product or service to a customer. The “support” actions may be considered non-value adding actions since they do not produce a valued product or service to a customer. Support action categories 56 utilized herein include a preparation action category 64 associated with plan phase 52. A storage action category 66, a transporting action category 68, and an automation action category 70 are all associated with execute phase 52. A process control action category 72 is associated with control and monitor phase 52. A processing defects action category 74 and a processing waste action category 76 are associated with improve phase 52. The various primary and support action categories 54 and 56, respectively, can be used to sort the various actions within business process 16 (FIG. 1) in preparation for quantification in accordance with the present invention. The present invention quantifies both value adding and non-value adding actions of business process 16 (FIG. 1) to determine whether the actions are in alignment with the objectives of business process 16.

Referring to FIG. 4 in connection with FIG. 3, FIG. 4 shows a table 78 of action categories 53 including primary and support action categories 54 and 56, respectively, and their definitions 80 utilized in an embodiment of the present invention.

Business process actions that can be categorized into primary action categories 54 are primary, or value adding actions. Primary actions fall within planning action category 58 are those that entail the preparation for doing or making something prior to process execution. Actions falling within execution action category 60 are those that entail making or producing a product or deliverable, and actions falling within prevention action category 62 are those that entail ensuring the quality of products or deliverables by taking certain steps to prevent poor quality.

Business process actions that can be categorized into support action categories 56 are support, or non-value adding actions. Support actions that fall within preparation action category 64 are those that entail making an object ready or suitable for a specific purpose. Actions falling within storage action category 66 are those that entail placing or leaving a product or deliverable for archiving or later use, or for retaining waste for disposal at a later time. Actions falling within transporting action category 68 are those that entail the transportation or movement of parts, materials, or information. Actions falling within automation action category 70 are those that entail information systems processes involving the use of technology. Actions falling within process control action category 72 are those that entail checking, testing, and verifying by evidence or experiment on a product or deliverable. In addition, actions falling within process control action category 72 are those that assure conformance to regulatory requirements. Actions falling within processing defects action category 74 are those that entail handling products or deliverables that do not meet the specifications and requirements of business process 16 (FIG. 1). Actions falling within processing waste action category 76 are those that entail the elimination or processing of scrap or waste, where scrap refers to work that cannot be reworked or redone.

Table 78 provides an exemplary listing of primary and support action categories 54 and 56, respectively. Those skilled in the art will understand that other action categories 53 may be derived for the quantification of business processes within other organizations or entities.

FIG. 5 shows a table 82 of action verb database 48 that includes action verbs 84 and their corresponding action type designators 86 and action category designators 88 utilized in conjunction with the present invention. In accordance with common business process analysis practices, activities within business process 16 can be simplified by using a simple sentence structure and action verb technique to label each of the activities of business process 16. As such, business process 16 can be broken down into a plurality of sentence structures each of which includes one of action verbs 84 that best describes the action in a particular activity of business process 16.

Each of action verbs 84 has associated therewith one of action type designators 86. In this scenario, designators 86 differentiate between a primary action 90 and a support action 92. Primary action 90 identifies those actions within business process 16 that that produce a valued physical product, information, report, or service to a customer. Support action 92 identifies those actions within business process 16 that support the business, but do not produce a valued product or service to a customer.

In addition, each of action verbs 84 has associated therewith one of action category designators 88. The particular one of action categories 53 (FIG. 3) specified by action category designator 88 is selected from the set of action categories 53 of primary and support action categories 54 and 56, respectively, listed and defined in table 78 (FIG. 4).

Action verb database 48 is utilized to provide guidance in evaluating whether actions, represented by action verbs 84, used in identifying activities within business process 16 (FIG. 1) are primary actions 90 (i.e., value adding) or support actions 92 (i.e., non-value adding). In addition, action verb database 48 is utilized to provide guidance in categorizing each of the actions into one of action categories 53 selected from the set of primary and support action categories 54 and 56, respectively. By way of example, a sentence structure within business process 16 may be as follows “the manufacturing department assembles a component.” The action of assembling a component is characterized by action verb 84 of “assemble.” Referring to action database 48, action type designator 86 for “assemble” action verb 84 is primary (value adding) action 90, and action category 53 for “assemble” action verb 84 is execution action category 60.

Table 82 shows only a small subset of an entire action verb database 48 of action verbs 84 that are most frequently utilized in the process definition and analysis phase of a project. Table 82 can include numerous action verbs 84. In addition, table 82 can be updated to include additional action verbs 84 to more adequately describe actions occurring as part of business process 16 (FIG. 1). For example, table 82 includes a “date added” region 94 that may be used to record when an additional one of action verbs 84 is added to update table 82. In some instances, an action verb 84 may alternately or secondarily be categorized into another one of action categories 53 (FIG. 3). This alternate one of action categories 53 can also be associated with action verb 84 in an “alternate category” region 96 of table 82.

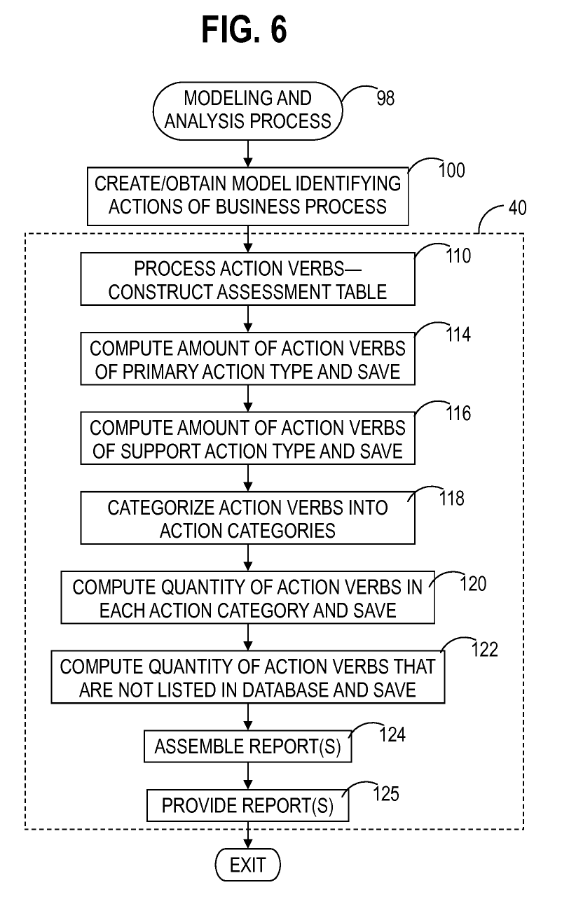

FIG. 6 shows a flowchart of a modeling and analysis process 98 in accordance with the present invention. Modeling and analysis process 98 is embodied as business process modeler and analyzer executable code 36 (FIG. 2) contained on computer-readable storage medium 34 (FIG. 2) and executed by processor 24 (FIG. 2). Process 98 describes computer-assisted methodology for analyzing business process 16 (FIG. 1) within an organization.

Process 98 begins with a task 100. At task 100, business process model 42 (FIG. 2) is created or otherwise obtained. It may be recalled that code 36 includes business process modeler segment 38 that diagrams the actions within business process 16 to create business process model 42 stored in memory system 32 (FIG. 2) of computing system 20 (FIG. 2). Business process modeler segment 38 may be realized by a number of existing and upcoming business process modeling programs. In addition, business process modeler segment 38 and business process analyzer segment 40 may be realized as a single, integrated process, i.e., code 36. In such a situation, business process model 42 may be created by modeler segment 38 in response to business process definition input parameters 44 (FIG. 2). Alternatively, business process modeler segment 38 and business process analyzer segment 40 may be distinct physical units both of which are executed on computing system 20 (FIG. 2) or each of which are executed on different computing systems. In such an instance, business process model 42 is obtained for storage in memory system 32 and for subsequent analysis by business process analyzer segment 40.

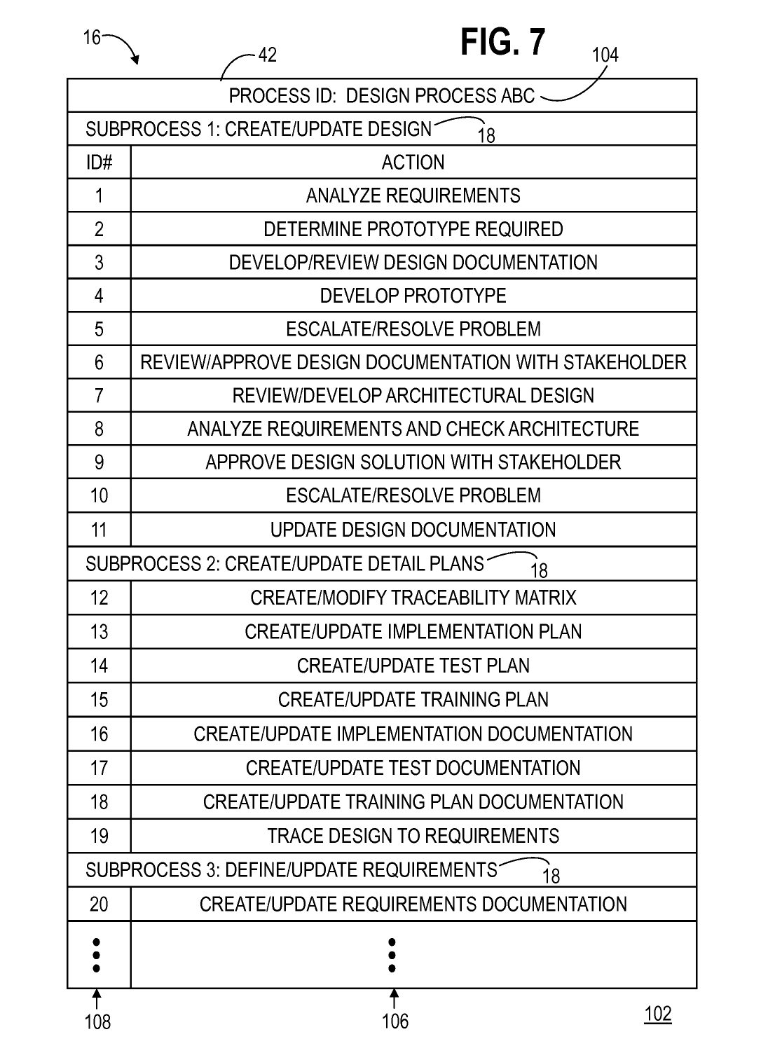

Referring to FIG. 7 in connection with task 100, FIG. 7 shows a table 102 exemplifying a number of actions 106 that are part of business process 16. Table 102 represents a portion of business process model 42 created or otherwise obtained through the execution of task 100.

Table 102 includes a process identifier 104 identifying business process 16. In this illustration, business process 16 is subdivided into its corresponding sub-processes 18. Within each of sub-processes 18 is a list of actions 106 distinguished by action identifiers 108. Actions 106 are the activities required to carry out each of sub-processes 18 of business process 16. As shown by way of example, process identifier 104 identifies business process 16 as “Design Process ABC”. A first one of sub-processes 18 is “Create/Update Design.” Actions 106 within “Create/Update Design” sub-process 18 include: Analyze Requirements, Determine Prototype Required, Develop/Review Design Documentation, and so forth. Similarly, a second one of sub-processes 18 is “Create/Update Detail Plans” with actions 106 that include Create/Modify Traceability Matrix, Create/Update Implementation Plan, Create/Update Test Plan, and so forth.

Only actions 106 for two sub-processes 18 and a portion of a third sub-process 18 are shown for brevity. However, many other sub-processes 18 and their associated actions 106 may be included in table 102 of business process model 42. In addition, actions 106 and sub-processes 18 are provided in tabular form in table 102 and may be utilized as such by modeling and analysis process 98. However, those skilled in the art will recognize that business process model 42 may be diagrammed to include additional information that makes it easy for business users as well as developers to understand the flow of business process 16. Additional information includes, for example, flow objects (events, activities, gateways), connecting objects (sequence flow, message flow, association), swimlanes (pool, lane), artifacts (data objects, group, annotation), and the like.

Referring back to FIG. 6, modeling and analysis process 98 continues with a task 110 following task 100. Task 110 and the remaining tasks of modeling and analysis process 98 are embodied as business process analyzer segment 40 of business process modeler and analyzer executable code 36 (FIG. 2) contained on computer-readable storage medium 34 (FIG. 2). Analyzer segment 40 identifies action verb 84 (FIG. 5), one of primary action 90 and support action 92 from action type designator 86 (FIG. 5), and one of action categories (FIG. 3) from action category designator 88 (FIG. 5) for each of actions 106 (FIG. 7) within business process model 42. Knowledge of action verbs 84, primary and support actions 90 and 92, and action categories 53 is used to produce quantitative analysis of business process 16 that is provided to a user in an easy to interpret report 22 (FIG. 2). Report 22 can, in turn, undergo a more detailed analysis by a business process management (BPM) practitioner. Through the automated analysis provided by business process analyzer segment 40, a documented business process 16 can be objectively analyzed to determine if the purpose of the business process 16 is in alignment with its objectives. Moreover, provision of the objective report 22 can be used to identify areas for business process improvement.

At task 110, action verbs 84 (FIG. 5) for each of actions 106 (FIG. 7) are processed and an assessment table is constructed. Processing entails ascertaining one of action verbs 84 for each of actions 106 that best describes that action 106. Processing further entails identifying from action verb database 48 (FIG. 5) one of primary and support action 90 and 92 from action type designator 86 (FIG. 5) associated with each of the action verbs 84 and determining action categories 53 from action category designators 88 associated with each of action verbs 84. Constructing entails the development of an assessment table that compiles the processing information.

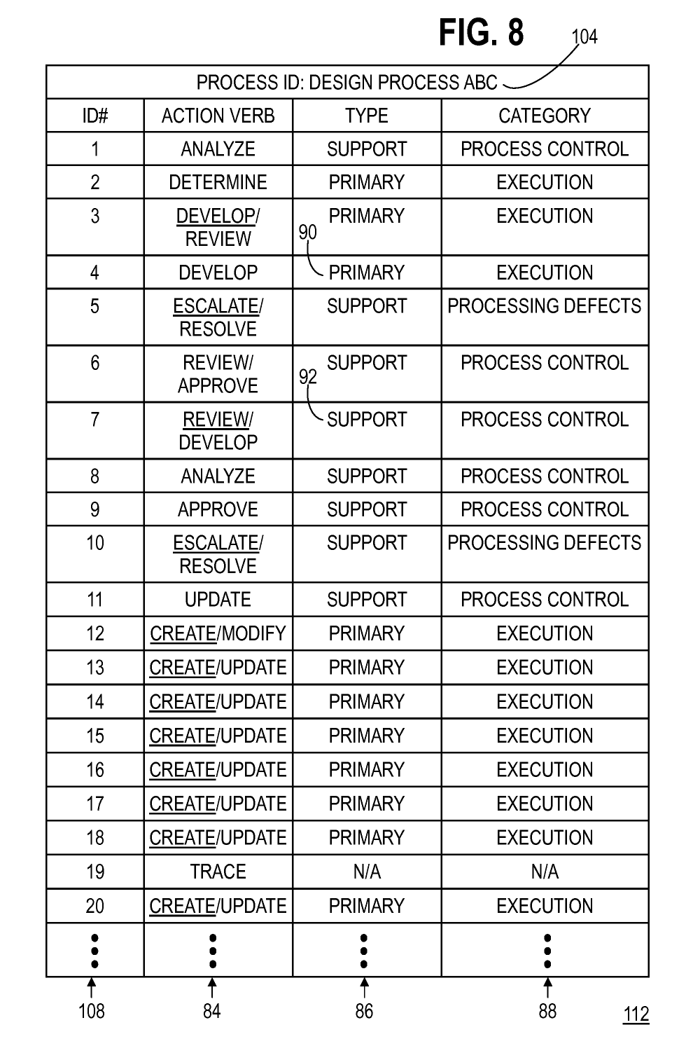

Referring to FIG. 8 in connection with task 110, FIG. 8 shows a table 112 of an assessment of actions 106 of business process model 42 (FIG. 7) in accordance with the present invention. Table 112 includes action identifiers 108 that correlate with each of actions 106 (FIG. 7) within business process model 42. Action identifiers 108 are equivalent to those presented in table 102 of business process model 42.

Table 112 further includes action verbs 84 associated with action identifiers 108. In addition, one of action type designators 86 (identifying either primary action 90 or support action 92), and one of action category designators 88 (identifying one of action categories 53) is associated with each of action verbs 84. In some instances, an action verb 84 describing one of actions 106 may not be included within action verb database 48. This is noted in table 112 by the label “N/A” as exemplified in connection with action identifier 108, labeled “19.”

In general, each of actions 106 correlated with action identifiers 108 has one of action verbs 84 associated therewith. In some instances, two action verbs 84 may be associated with one of action identifiers 108. If such is the case, the one of action verbs 84 that best describes its one of actions 106 is selected for analysis. This is noted in table 112 in which the underlined one of action verbs 84 represents the best description of its action 106.

With continued reference to FIGS. 6 and 8, following assessment of actions 106 of business process model 42 and the construction of table 112, process 98 continues with a series of computation tasks.

That is, a task 114 is performed to compute an amount of action verbs 84 within table 102 having action type designator 86 that is identified as being primary action 90. The total amount of actions 106 that are identified as primary action 90 is then saved.

A task 116 is performed to compute an amount of action verbs 84 within table 102 having action type designator 86 that is identified as being support action 92. The total amount of actions 106 that are identified as support action 92 is then saved.

Next, a task 118 is performed to categorize action verbs 84 within table 102 by action categories 53 (FIG. 3) as identified by action category designators 88.

In response to task 118, a task 120 is performed to compute a quantity of action verbs 84 within table 102 for each of action categories 53. These quantities are then saved.

Next, a task 122 is performed to compute any of action verbs 84 identified within table 102 that are not listed in action verb database 48 (FIG. 5).

The quantitative data obtained through the execution of computation tasks 114, 116, 120, and 122 is used to assemble report 22 at a subsequent task 124.

Following task 124, a task 125 is performed in which report 22 is provided to a user via output element 28 (FIG. 2) and/or display 30 (FIG. 2). Following task 125, modeling and analysis process 98 exits.

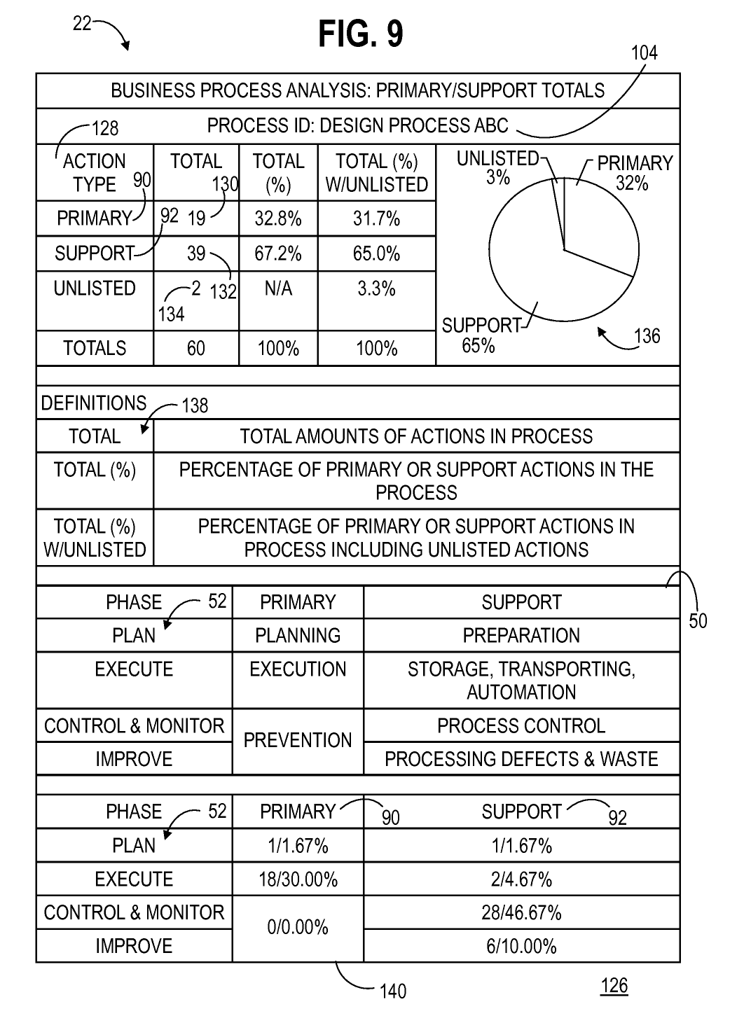

FIG. 9 shows a diagram 126 of a first portion of report 22 generated in response to the execution of modeling and analysis process 98 (FIG. 6) and provided to a user. Diagram 126 shows amounts of actions 106 (FIG. 7) of business process 16 (FIG. 1) that are identified as being primary actions 90 and support actions 92. Diagram 126 provides a sample illustration of the quantified data that may be included within report 22 for provision to a user. However, it will become apparent that diagram 126 can include more or less information then that which is shown.

Diagram 126 includes process identifier 104 identifying business process 16 (FIG. 1). Diagram 126 further includes a table portion 128 that distinguishes a first amount 130 of actions 106 that are primary actions 90 and a second amount 132 of actions 106 that are support actions 92. First and second amounts 130 and 132, respectively, may be presented as numerical values, as percentages that do not account for an amount 134 of unlisted action verbs 84 (FIG. 5), i.e., those that were not listed in action verb database 48 (FIG. 5), and/or as percentages that do account for amount 134 of action verbs 84 that were not listed in action verb database 48.

In this scenario, table portion 128 is associated with a graphical representation, i.e., a pie chart 136, of the information provided in table portion 128. Pie chart 136 is divided into sectors illustrating relative magnitudes or percentages proportional to the quantity of the whole. Through the provision of pie chart 136, a user can readily ascertain the relative proportion of primary actions 90 to support actions 92. Since support actions 92 are non-value adding, a user may be alerted to an undesirably high proportion of support actions 92 relative to primary actions 90 within business process 16 (FIG. 1).

While the pie chart is one of the most ubiquitous statistical charts in the business world and the mass media, the present invention is not limited to such a visual representation. Alternatively, or in addition, report 22 may include other plots such as a bar chart, dot chart, or other graphical and non-graphical techniques for visually representing information. In addition, report 22 may include assessment table 112 (FIG. 8).

Diagram 126 may include additional information that enables a user to interpret the data being presented therein. For example, diagram 126 includes definitions 138 corresponding to information presented in table portion 128. Diagram 126 may also include table 50 of phases 52 of a business process life cycle, and a table 140 that sorts or catalogs amounts and percentages of primary action types 90 and support actions 92 by phases 52 of the business process life cycle in accordance with their action categories (FIG. 3).

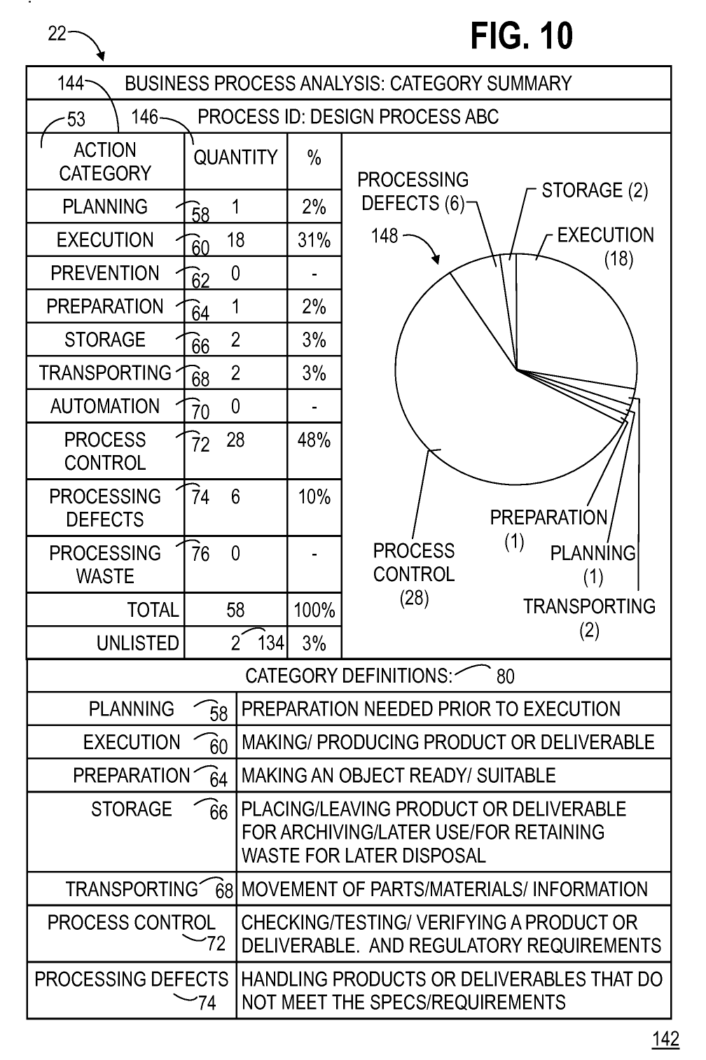

FIG. 10 shows a diagram 142 of a second portion of report 22 generated in response to the execution of modeling and analysis process 98 (FIG. 6) and provided to a user. Diagram 142 shows quantities of actions 106 (FIG. 7) of business process 16 (FIG. 1) categorized by action categories 53. Diagram 142 provides a sample illustration of the quantified data that may be included within report 22 for provision to a user. However, it will become apparent that diagram 142 can include more or less information then that which is shown. Diagram 142 may be provided to a user in addition to diagram 126 to form the entirety of report 22. Alternatively, a user may only be provided with diagram 126 (FIG. 9) or diagram 142 or some combination of a subset of the information provided in both of diagrams 126 and 142.

Diagram 142 includes process identifier 104 identifying business process 16 (FIG. 1). Diagram 142 further includes a table portion 144 that distinguishes quantities 146 of actions 106 categorized by action categories 53. Quantities 146 may be presented as numerical values and/or as percentages that may or may not account for amount 134 of unlisted action verbs 84.

In this scenario, table portion 144 is associated with a graphical representation, i.e., a pie chart 148, of the information provided in table portion 144. Pie chart 148 is divided into sectors illustrating relative magnitudes proportional to the quantity of the whole. Through the provision of pie chart 148, a user can readily ascertain the relative proportions of each of actions 106 categorized by action categories 53. Pie chart 148 can enable a user to determine whether business process 16 (FIG. 1) is alignment with the objectives of business process 16. For example, if business process 16 has planning as its objective, the categorization of actions into action categories can enable a user to determine whether quantity 146 of actions 106 categorized into planning action category 58 is sufficient, or in alignment with the planning objective of business process 16. Again, although a pie chart is presented herein, report 22 may include other plots such as a bar chart, dot chart, or other graphical and non-graphical techniques for visually representing information.

Diagram 142 may include additional information that enables a user to interpret the data being presented therein. For example, diagram 142 includes definitions 80 corresponding for the particular action categories 53 that had non-zero quantities of actions 106 associated therewith.

Modeling and analysis process 98 (FIG. 6) may be executed to quantify business process model 42 (FIG. 2) in an “as is” state. However, modeling and analysis process 98 is not limited to such a use. For example, upon review and analysis of report 22, in the form of diagram 126 (FIG. 9) and diagram 142, a business analyst may modify business process model 42 (FIG. 2), and re-execute process 98 for the modified business process model. A new report 22 quantifying the modified business process model 42 can be compared with the “as is” report of business process model 42 to determine whether the changes suggested by the modifications to business process model 42 may yield an improvement in the actual performance of business process 16 (FIG. 1).

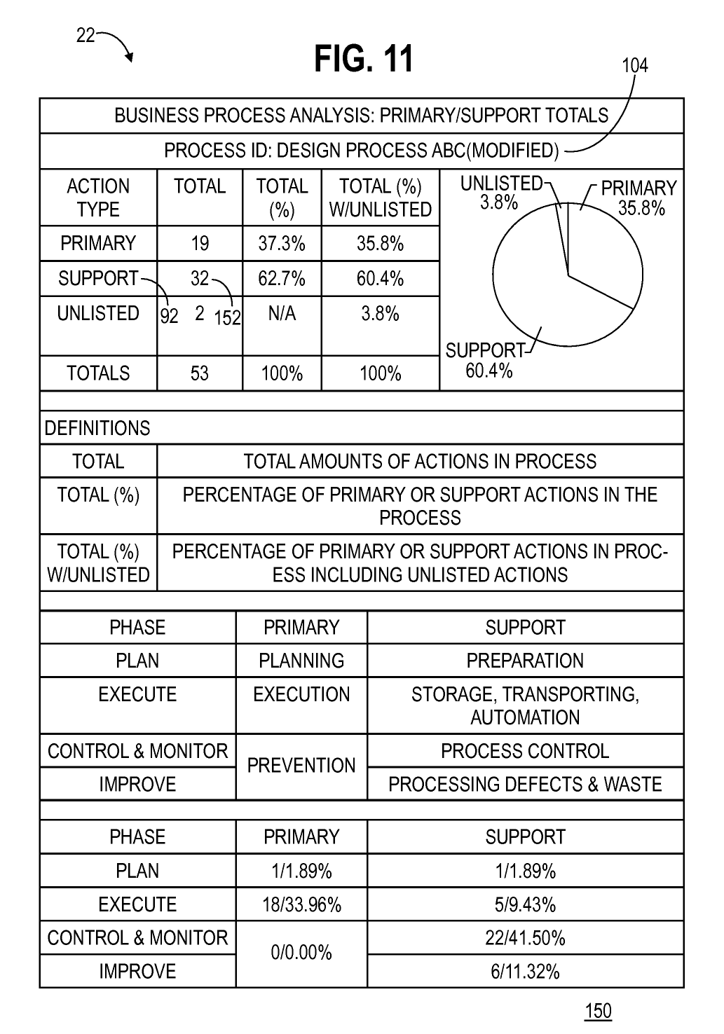

FIG. 11 shows a diagram 150 of report 22 provided in response to a subsequent execution of process 98. In this exemplary diagram 50 showing the analysis results of modified business process model 42, an amount 152 of support actions 92 has been reduced relative to amount 132 of support actions 92 shown in diagram 126 (FIG. 9). Modeling and analysis process 98 may be re-executed in response to modification of business process model 42 (FIG. 2) representing business process 16 in a “to be” state. Diagram 150 shows a first portion of report 22 that can be provided to a user. Diagram 150 shows amounts of actions 106 (FIG. 7) of the modified business process 16 (FIG. 1) that are primary actions 90 and support actions 92. Diagram 150 can be directly compared with diagram 126 (FIG. 9) to determine the efficacy of business process 16 in a “to be” state, i.e. modified, relative to business process 16 in the current “as is” state.

Referring briefly to FIG. 9, since actions 106 within business process 16 that are support actions 92 are non-value adding actions 106, review of diagram 126 may reveal that amount 132 of actions 106 that are support actions 92 should be reduced. Diagram 150 represents quantified data in which the number of actions 106 that are support actions 92 has been reduced in the modified business process 16. An analyst can use this quantified information to make decisions regarding business process improvement. Although report 22 of the modified business model 42 includes diagram 150 distinguishing primary actions 90 from support actions 92, it should be understood that report 22 may additionally include a diagram (not shown) distinguishing action categories 53 (FIG. 3) similar to that provided in FIG. 10.

In summary, the present invention teaches a method, executable code, and a system for analysis of a business process within an organization. The method, executable code, and system provide objective analysis criteria in easy to interpret reports that lend themselves to more detailed analysis by a business process modeling practitioner. The present invention works effectively with existing and upcoming business process modeling methodologies used for documenting process tasks, and provides an automated, objective means for analyzing process improvement.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented.

What is claimed is:

1. A method for computer-assisted analysis of a business process within an organization, said method comprising:
obtaining a model of said business process, said model identifying actions that are part of said business process;
categorizing each of said actions into an action category selected from a set of action categories;
computing a quantity of said actions for each said action category from said set;
assembling a report in response to said computing operation, said report including a visual representation of said quantity of said actions for said each action category; and
providing said report to a user so that said user can visualize an efficacy of said business process.

2. A method as claimed in claim 1 wherein said obtaining operation comprises utilizing said model of said business process created by a business process modeler, said business process modeler diagramming said actions within said business process.

3. A method as claimed in claim 1 wherein:
said method further comprises constructing, prior to said categorizing operation, an action database that includes a listing of action verbs, each of said action verbs having an action category designator assigned thereto, said actions of said business process include action verbs associated therewith; and
said categorizing operation includes utilizing said action database to categorize said each of said actions in accordance with said action category designator.

4. A method as claimed in claim 3 further comprising modifying said action database to include an updated listing of said action verbs, each of said action verbs of said updated listing having said action category designator assigned thereto.

5. A method as claimed in claim 1 wherein said set of action categories includes planning, execution, prevention, preparation, storage, transporting, automation, process control, processing defects, and processing waste action categories.

6. A method as claimed in claim 1 further comprising:
identifying those of said actions that are primary actions, said primary actions describing value adding activities of said business process;
identifying others of said actions that are support actions, said support actions describing non-value adding activities within said business process; and
distinguishing, within said report, a first amount of said primary actions from a second amount of said support actions within said business process.

7. A method as claimed in claim 6 wherein:
said set of action categories includes primary action categories and support action categories;
said categorizing operation categorizes each of said primary actions into one of said primary action categories and categorizes each of said support actions into one of said support action categories;
said computing operation computes said quantity of primary actions for each of said primary action categories and computes said quantity of support actions for each of said support action categories; and
said method further comprises providing, within said report, said quantity of said primary actions for said each of said primary action categories and said quantity of said support actions for said each of said support action categories.

8. A method as claimed in claim 6 wherein:
said method further comprises constructing, prior to said categorizing operation, an action database that includes a listing of action verbs, each of said action verbs having one of an action type designator assigned thereto, said each of said actions of said business process includes one of said action verbs; and
said identifying said primary actions and said support actions includes utilizing said action database to identify said each of said actions in accordance with said action type designator.

9. A method as claimed in claim 1 further comprising:
associating said each of said action categories with one of various phases in a lifecycle of said business; and
presenting, in said report, each of said action categories associated with one of said phases to visualize an alignment of said actions with said various phases of said business process.

10. A method as claimed in claim 1 further comprising:
obtaining a second model of a modified business process, said second model identifying second actions that are part of said modified business process;
performing said categorizing and computing operations for said second actions of said modified business process;
assembling a second report that includes a second visual representation of a second quantity of said second actions for said each said action category; and
providing said second report to said user so that said user can visualize a potential efficacy of said modified business process relative to said business process.

11. A computer-readable storage medium containing executable code for instructing a processor to analyze a business process within an organization, said executable code instructing said processor to perform operations comprising:
obtaining a model of said business process, said model identifying actions that are part of said business process;
identifying those of said actions that are primary actions, said primary actions describing value adding activities of said business process;
identifying others of said actions that are support actions, said support actions describing non-value adding activities within said business process;
computing a first amount of said primary actions and a second amount of said support actions;
providing a report to a user that distinguishes said first amount of said primary actions from said second amount of said support actions within said business process, said report enabling a user to visualize an efficacy of said business process.

12. A computer-readable storage medium as claimed in claim 11 further comprising an action database that includes a listing of action verbs, each of said action verbs having an action type designator assigned thereto, said each of said actions of said business process includes one of said action verbs; and
said identifying said primary actions and said support actions includes utilizing said action database to identify said primary actions and said support actions in accordance with said action type designator.

13. A computer-readable storage medium as claimed in claim 11 wherein said executable code instructs said processor to perform further operations comprising:
categorizing each of said primary actions into one of a set of primary action categories;
categorizing each of said support actions into one of a set of support action categories; and
providing, within said report, a quantity of said primary actions for each of said primary action categories and said quantity of said support actions for each of said support action categories.

14. A computer-readable storage medium as claimed in claim 13 further comprising an action database that includes a listing of action verbs, each of said action verbs having an action category designator assigned thereto, said each of said actions of said business process includes one of said action verbs; and
said categorizing said each of said primary and support actions includes utilizing said action database to categorize said each of said actions in accordance with said action category designator.

15. A computer-readable storage medium as claimed in claim 11 wherein said executable code instructs said processor to perform further operations comprising:
associating said each of said primary and support action categories with one of various phases in a lifecycle of said business process; and
presenting, in said report, each of said primary and support action categories associated with one of said phases to visualize an alignment of said primary and support actions with said various phases of said business process.

16. A computer-readable storage medium as claimed in claim 11 wherein said executable code instructs said processor to perform further operations comprising:
obtaining a second model of a modified business process, said second model identifying second actions that are part of said modified business process;
performing said identifying and computing operations for said second actions of said modified business process;
assembling a second report that includes a modified amount of at least one of said primary actions and said support actions within said business process; and
providing said second report to said user so that said user can visualize a potential efficacy of said modified business process relative to said business process.

17. A system for modeling and analyzing a business process within an organization comprising:
a processor;
a computer-readable storage medium;
executable code recorded on said computer-readable storage medium, said executable code including:
a business process modeler segment for instructing said processor to create a model of said business process, said model identifying actions that are part of said business process; and
a business process analysis segment for instructing said processor to categorize each of said actions into an action category selected from a set of action categories, compute a quantity of said actions for each said action category from said set, and assemble a report that includes a visual representation of said quantity of said actions for said each said action category; and
an output element, in communication with said processor, for providing said report to a user so that said user can visualize an efficacy of said business process.

18. A system as claimed in claim 17 further comprising an action database recorded on said computer-readable storage medium, said action database including a listing of action verbs, each of said action verbs having an action category designator assigned thereto, said each of said actions of said business process including one of said action verbs, and said business process analysis segment instructs said processor to utilize said action database to categorize said each of said actions in accordance with said action category designator.

19. A system as claimed in claim 18 wherein:
said each of said action verbs in said action database has an action type designator assigned thereto; and
said business process analysis segment instructs said processor to utilize said action database to identify those of said actions that are primary actions and others of said actions that are support actions in accordance with said action type designator and to distinguish, within said report, a first amount of said primary actions from a second amount of said support actions.

20. A system as claimed in claim 17 wherein:
said business process modeler segment further instructs said processor to create a second model of a modified business process, said second model identifying second actions that are part of said modified business process; and
said business process analysis segment further instructs said processor to categorize each of said second actions into one of said action categories, compute said quantity of said second actions for each said action category from said set, and assemble a second report that includes a visual representation of said quantity of said second actions for said each said action category; and
said output element provides said second report to said user so that said user can visualize a potential efficacy of said modified business process relative to said business process.
